(19) United States
(12) Patent Application Publication
(10) Pub. No.: US 2004/0252831 A1
(43) Pub. Date: Dec. 16, 2004

(54) Key expander, key expansion method, and key expansion program

(76) Inventor: Teruaki Uehara, Kanagawa (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/755,307

(22) Filed: Jan. 13, 2004

(30) Foreign Application Priority Data
Jun. 13, 2003 (JP) 2003-169150

(51) Int. Cl. H04L 9/00

(52) U.S. Cl. 380/44

(57) ABSTRACT

A key expander expands a secret key used in a common-key cryptographic scheme into a sequence of working keys that are used in one order for encryption and in the reverse order for decryption. The key expander includes registers that store a number of initial working keys sufficient to start the key expansion process in one direction. Toward the end of a key expansion cycle in this direction, an equivalent number of final working keys are stored in further registers, for use as initial keys when the working key sequence is generated in the opposite direction. The key expander is then ready to start key expansion in either direction without delay.

### BACKGROUND OF THE INVENTION

1. Field of the Invention

The present invention relates to a key expander, a key expansion method, and a program that can be used to implement a key expansion algorithm compatible with, for example, the Advanced Encryption Standard (AES).

2. Description of the Related Art

The AES algorithm was standardized in November 2001 as a successor to the Data Encryption Standard (DES) algorithm. The DES algorithm was developed for use by the United States government, but it has been widely adopted worldwide, being incorporated into the Internet Provider Security Protocol (IPsec) as an optional feature that IPsec vendors may include in their products, and as a required feature of the IPsec Encapsulating Security Payload (ESP) specification. As a successor to DES, AES is highly likely to see similar worldwide use.

Like the DES algorithm, the AES algorithm is a common-key cryptographic scheme, also referred to as a shared-key algorithm. With this type of algorithm, encrypted communication is possible because the transmitting and receiving communication devices share the same (secret) key. The transmitting communication device uses the shared key to encrypt plaintext data, and transmits the encrypted data. The destination communication device receives the encrypted data and uses the shared key to decrypt the received data, thereby recovering the plaintext data. In the AES algorithm, accordingly, the encryption key (the key used to encrypt data) and the decryption key (the key used to decrypt data) are the same.

Technology for implementing the AES algorithm in a compact circuit is disclosed in Japanese Unexamined Patent Application Publication No. 2003-1552.

In the AES algorithm and other similar algorithms, the encryption and decryption processes are carried out with a series of working keys generated from the shared key. The working keys are generated by successively repeating an operation that generates a new working key from one or more of the working keys used previously. The original working key or keys from which the process starts are obtained from the shared key. The necessary number of working keys varies, depending on the details of the encryption process, such as the size of the blocks into which the data to be encrypted are divided. The working keys are generated by a key expander, also referred to as a key scheduler. The actual encryption or decryption process is carried out by a data mixer that executes the same mixing process repeatedly, using a different working key each time. The necessary number of working keys is equal to the number of repetitions of the mixing process on each data block.

In FIG. 1, for example, the secret key is 128 bits long, and forty-four working keys WK1-WK44, each 32 bits long, are used. The secret key directly yields the first four working keys WK1-WK4, which are the initial encryption keys in this case. A key expander (not shown) generates working key WK5 from working keys WK4 and WK1, working key WK6 from working keys WK5 and WK2, and so on, working key WK44 being generated from working keys WK43 and WK40. When the data mixer executes the encryption process, the working keys WK1, WK2, WK3, . . . , WK44 are used in this order.

The key expander also generates working keys for the data mixer to use in the decryption process. Although the decryption working keys have the same values as the encryption working keys, the working keys are generated and used in the reverse order for decryption. In FIG. 1, for decryption, working keys WK44-WK41 are the initial decryption keys. The key expander generates working key WK40 from working keys WK43 and WK44, working key WK39 from working keys WK42 and WK43, and so on, working key WK1 being generated from working keys WK4 and WK5. When the data mixer executes the decryption process, the working keys WK44, WK43, WK42, WK41 . . . , WK1 are used in this order.

The working keys can be generated and used in two modes: a static mode and a dynamic mode.

In the static mode, all of the working keys WK1-WK44 are generated and stored ahead of time, and are read and used when needed. In the dynamic mode, the working keys are generated dynamically as the need arises, following the generating procedure described above. Just four working keys WK4-WK1 (the initial keys for encryption), from which the other working keys are generated, have to be prestored.

The static mode has the disadvantage of requiring extra storage capacity, because all forty-four working keys WK1-WK44 have to be prestored, but has the advantage that the desired working keys are always available for use. When the working keys are stored in an extremely small communication device such as a smart card or an integrated circuit (IC) tag, however, the large amount of storage capacity consumed for storing the working keys is likely to be a major drawback.

The dynamic mode has the advantage of saving storage space, because only four working keys (the initial encryption keys) have to be prestored, but at the start of decryption, to obtain the initial decryption keys (working keys WK44-WK41), it is necessary to start from the initial encryption keys (WK1-WK4), since these are the only working keys stored. Considerable processing must therefore take place before the initial decryption keys WK44-WK41 are obtained and decryption can start. In addition, even after the initial decryption working keys are generated, depending on the internal state of the communication device at the time, further processing may be necessary to change the internal state before the decryption process can actually be executed.

### SUMMARY OF THE INVENTION

An object of the present invention is to perform dynamic key expansion without delays between encryption and decryption.

The invention provides a key expander for generating N working keys from a secret key used in a common-key cryptographic scheme, where N is a positive integer. The N working keys are used in a predetermined order in an encryption cycle and in the reverse order in a decryption cycle. The key expander has an operation unit that generates successive working keys from preceding working keys in either the predetermined order or the reverse order.

The key expander also has M working key registers, where M is a positive integer less than N. The M working key registers are linked to form a shift register from which the working keys are supplied to the operation unit and output one by one for use in encryption and decryption. The working keys generated by the operation unit are input to and shifted through the shift register.

An additional M encryption key registers, each coupled to a corresponding one of the M working key registers, store the first M working keys in the predetermined order for transfer into the M working key registers to start an encryption cycle. An additional M decryption key registers, each coupled to a corresponding one of the M working key registers, store the last M working keys in the predetermined order for transfer into the M working key registers to start a decryption cycle.

The last M working keys output in an encryption cycle are also transferred into the M decryption key registers and stored in preparation for a decryption cycle. Alternatively, the last M working keys output in a decryption cycle are also transferred into the M encryption key registers and stored in preparation for an encryption cycle. These transfers may be performed simultaneously with the shifting of the working keys through the shift register.

The secret key may have different possible bit lengths, in which case selectors are preferably provided for selecting different working key registers from which to supply working keys to the operation unit and into which to receive the working keys generated by the operation unit, depending on the bit length of the secret key.

The invented key expander requires advance storage of only enough working keys to start the key expansion process in one direction, either the encryption direction or the decryption direction. Nevertheless, by the end of the first key expansion cycle, the key expander has also stored the initial working keys needed to start the key expansion process in the opposite direction, and is ready to provide working keys for subsequent encryption and decryption cycles without delay.

### BRIEF DESCRIPTION OF THE DRAWINGS

In the attached drawings:

FIG. 1 illustrates the order in which working keys are used in the AES algorithm;

FIG. 2 schematically shows an example of the overall structure of a cryptographic communication system;

FIG. 3 schematically shows an example of the structure of a cryptographic processor usable in the communication system in FIG. 2;

FIG. 4 is a program listing illustrating an encryption key expansion algorithm usable in the present invention;

FIG. 5 is a program listing illustrating a decryption key expansion algorithm usable in the present invention;

FIG. 6 is a block diagram schematically showing an example of a key expander embodying the present invention;

FIGS. 7, 8, 9, and 10 schematically show examples of the internal structure of the register sets in FIG. 6; and

FIG. 11 shows a variation of the internal structure in FIG. 7.

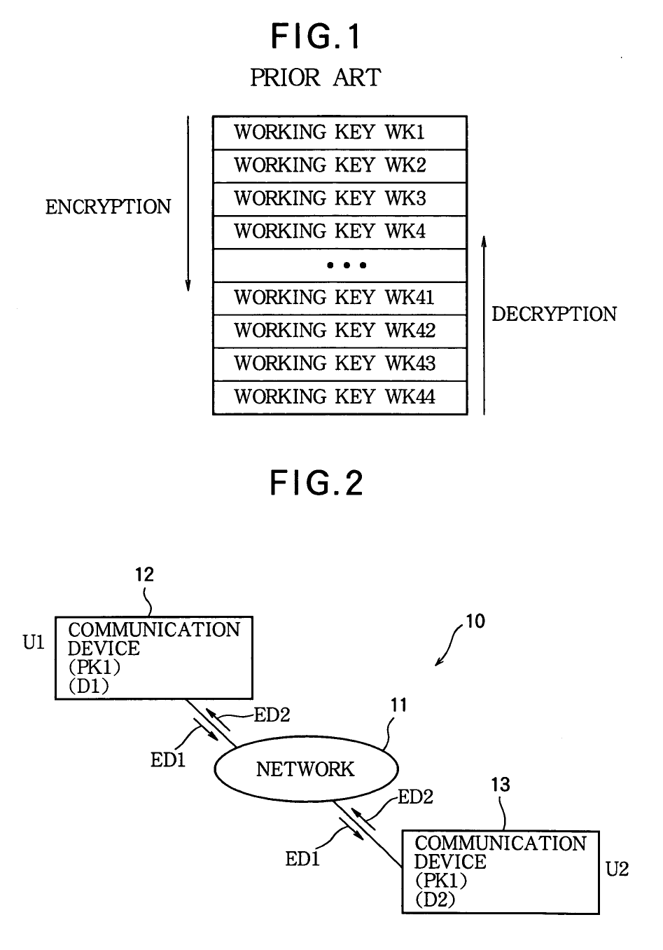

### DETAILED DESCRIPTION OF THE INVENTION

A key expander and key expansion method embodying the present invention for use in AES cryptography will now be described with reference to the attached drawings, in which like elements are indicated by like reference characters. The key expansion method can also be embodied in a machine-executable key expansion program.

Referring to FIG. 2, a communication system 10 in which the present invention may be used comprises a network 11 linking two communication devices 12, 13 that share the same secret key (PK1). Both communication devices 12, 13 transmit and receive encrypted data; for example, communication device 12 encrypts plaintext data D1 to generate encrypted data ED1, transmits the encrypted data ED1, receives encrypted data ED2, and decrypts the received data to recover plaintext data D2. Each communication device has a cryptographic processor that implements the encryption and decryption functions.

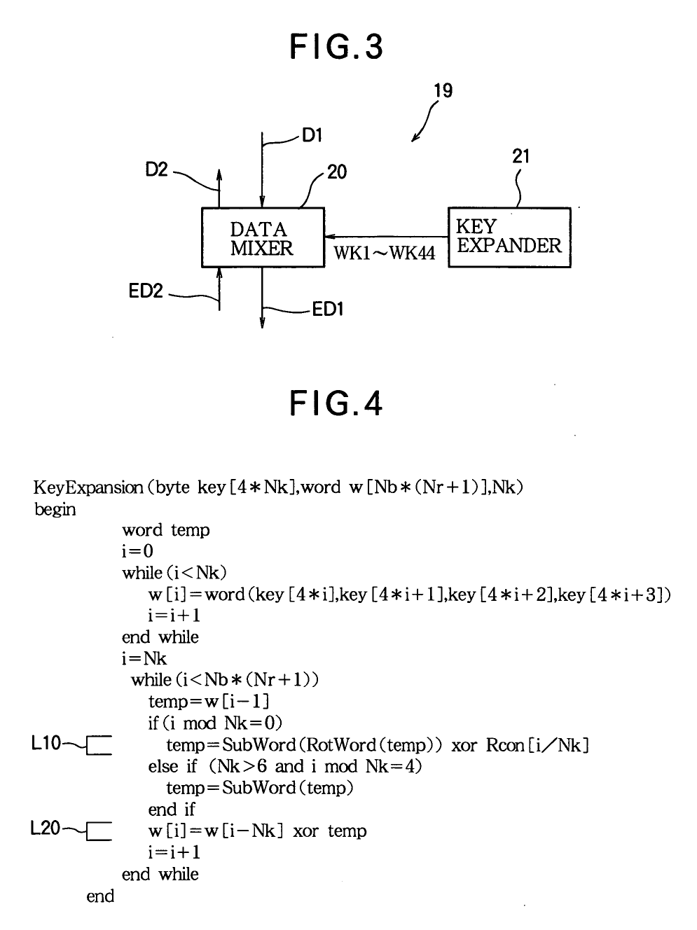

Referring to FIG. 3, the cryptographic processor 19 comprises a data mixer 20 and a key expander 21.

In the key expander 21, the working keys used by the data mixer 20 are generated from the shared secret key, which is also referred to as an initial key. The AES algorithm permits 128-bit, 192-bit, and 256-bit secret keys. The number of working keys generated (forty-four, fifty-five, or sixty) varies depending on the size of the secret key. If the size of a working key is 32 bits, the total size of all the working keys is 1,408 (=32×44) bits when the secret key size is 128 bits, 1,664 (=32×55) bits when the secret key size is 192 bits, and 1,920 (=32×60) bits when the secret key size is 256 bits.

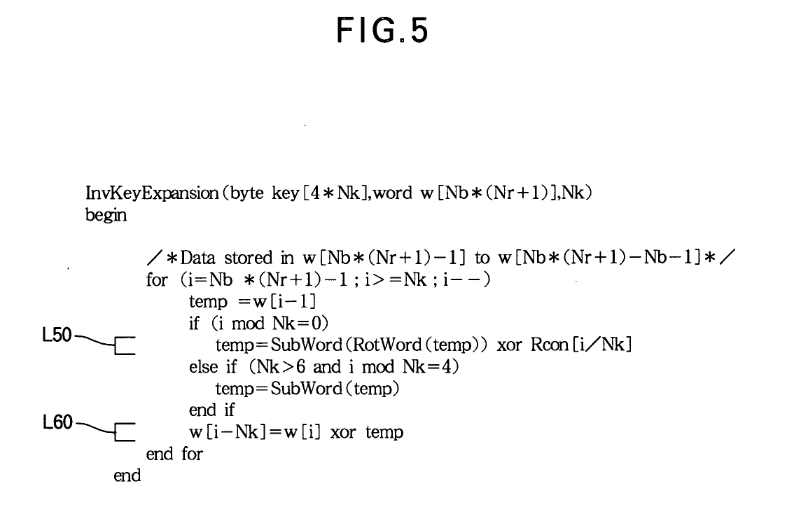

FIG. 4 shows the encryption key expansion algorithm by which the key expander 21 generates the working keys for encryption; FIG. 5 shows the decryption key expansion algorithm by which the key expander 21 generates the working keys for decryption. Both algorithms are shown as functions coded in a well-known high-level computer language.

In FIGS. 4 and 5, the size of the secret key (PK1) is given by the value of a parameter Nk as a multiple of four bytes (32 bits). Nk is four when the secret key size is 128 bits, six when the secret key size is 192 bits, and eight when the secret key size is 256 bits. Nb indicates the number of words of key data used in each round of the computation; in these algorithms, Nb is equal to four. Nr indicates the number of rounds: Nr is ten when the secret key PK1 has a size of 128 bits, twelve when the secret key size is 192 bits, and fourteen when the secret key size is 256 bits. The algorithms in FIGS. 4 and 5 are executed with a 32-bit data width.

If the secret key PK1 has a size of 128 bits, the encryption key expansion algorithm in FIG. 4 can be expressed by the following equation (1), where Wk_Key(N) is the N-th working key, the letter ‘f’ indicates an expansion computational process, and the symbol (+) indicates a bitwise exclusive OR operation.

Wk_{—}Key(N+4)=f(Wk_{—}Key(N+3))(+)Wk_{—}Key(N) (1)

The decryption key expansion algorithm in FIG. 5 can be expressed by the following equation (2).

Wk_{—}Key(N−4)=f(Wk_{—}Key(N−1))(+)Wk_{—}Key(N) (2)

Communication device 13, which communicates with communication device 12 over the network 11, has the same encryption and decryption functions as communication device 12. Communication device 12 is operated by a user U1, and communication device 13 by a user U2. Communication device 13 transmits encrypted data ED2 and receives encrypted data ED1. The exchange of the encrypted data ED1 and ED2 via the network 11 corresponds to an exchange of messages between users U1 and U2.

As described above, since the AES algorithm is a shared-key algorithm, the communication devices 12, 13 have the same secret key PK1. The network 11 may be a local area network (LAN), or a more broadly based network such as the Internet. The communication devices 12, 13 may be personal computers, smart cards, or IC tags. If one of the communication devices 12, 13 is a smart card or IC tag, the exchange of encrypted data ED1 and ED2 is often implemented by local communication such as direct wireless transmission, not passing through a network 11.

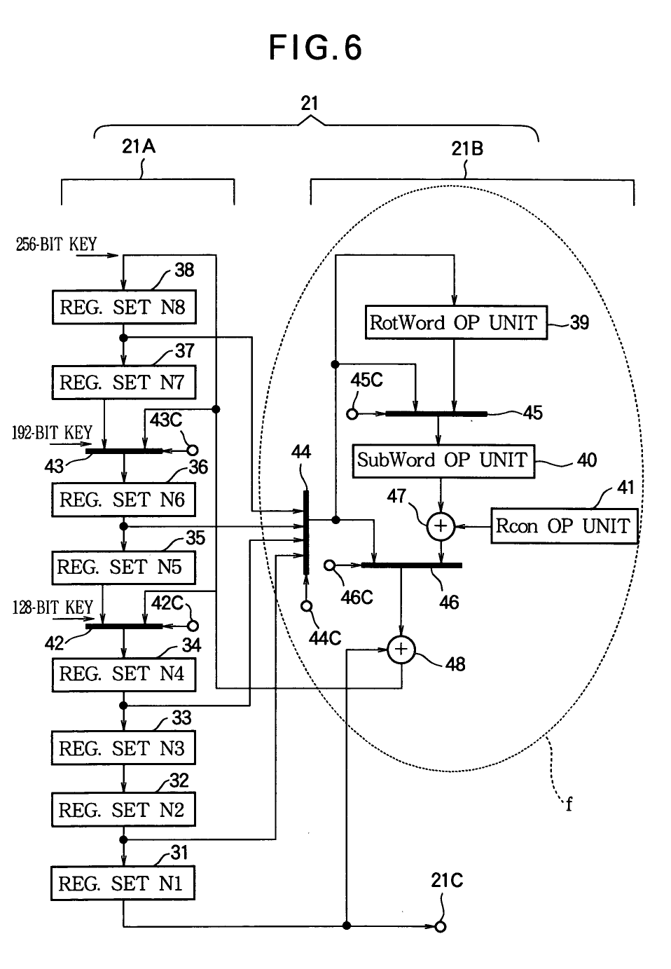

Referring to FIG. 6, a key expander 21 in which the present invention may be used comprises a register unit 21A, a key expansion operation section 21B, and an output terminal 21C.

The register unit 21A comprises eight register (REG.) sets 31-38 and two selectors 42, 43. The key expansion operation section 21B comprises three operation (OP) units 39-41, three selectors 44-46, and two exclusive-OR logic circuits 47, 48.

The working keys WK1-WK44 are output from the output terminal 21C to the data mixer 20. The working keys are output in the order WK1, WK2, WK3, WK4, . . . , WK43, WK44 when the data mixer 20 executes the encryption process, and in the reverse order when the data mixer 20 executes the decryption process. As described above, the data mixer 20 uses each received working key (WK1, for example) to execute a mixing process. The repeated mixing processes are necessary to enhance the strength (security) of the cipher by imparting a nonlinear property to defeat a decipherment attack by a third party on the network 11 (a party other than the users U1 and U2) who may try to learn the content of the plaintext data (D1, for example) or the encryption key (the secret key PK1, for example).

In the register unit 21A, the eight register sets 31-38 are ranked in order from N1 to N8: register set 31 has rank N1; register set 32 has rank N2; register set 33 has rank N3; register set 34 has rank N4; register set 35 has rank N5; register set 36 has rank N6; register set 37 has rank N7; register set 38 has rank N8.

The register unit 21A as a whole has the structure of a single shift register, and the set ranks N1-N8 designate the order of shifting of the data (the working keys) stored in the registers. A working key is shifted from higher to lower register sets in the set ranking. For example, the working key stored at set rank N8 at a certain time is first shifted from the register set 38 with set rank N8 to the register set 37 with set rank N7, and is then shifted successively from the register set 37 with set rank N7 to the register set 36 with set rank N6, from the register set 36 with set rank N6 to the register set 35 with set rank N5, . . . , from the register set 33 with set rank N3 to the register set 32 with set rank N2, and from the register set 32 with set rank N2 to the register set 31 with set rank N1.

Since secret keys of three different sizes can be used in the AES algorithm as described above, some of the higher-ranked register sets in the register unit 21A may not be used, depending of the size of the secret key. More specifically, when the secret key PK1 has a size of 256 bits, all eight register sets 31-38 are used. When the secret key PK1 has a size of 192 bits, the six lower register sets 31-36 are used but the two highest register sets 38, 37 are not used. When the secret key PK1 has a size of 128 bits, the four lower register sets 31-34 are used but the four higher register sets 38-35 are not used.

The description below will mainly treat the case in which the secret key PK1 size is 128 bits and of the register sets 31-38, only register sets 31-34 are used.

Selector 42 in the register unit 21A has two data input terminals and a data output terminal. The selection of the input terminal connected to the output terminal is switched according to a selector control signal (not shown) supplied to a control input terminal 42C. Selector 43 has a similar structure with two input terminals and an output terminal, and is controlled by a selector control signal supplied to a control input terminal 43C. The selector control signals supplied to the control input terminals 42C, 43C are switched depending on the size of the secret key PK1. For example, when the secret key PK1 has a size of 256 bits, selector 43 connects register set 37 to register set 36, and selector 42 connects register set 35 to register set 34. When the secret key PK1 has a size of 192 bits, selector 43 connects exclusive OR circuit 48 to register set 36, and selector 42 connects register set 35 to register set 34.

When the secret key PK1 has a size of 128 bits as assumed in the present embodiment, selector 42 connects exclusive OR circuit 48 to register set 34. Since the four lower register sets 31-34 are then disconnected from the four higher register sets 35-38, selector 43 may be set to either selection state.

The functions of selectors 44-46 in FIG. 6 are similar to the functions of selectors 42 and 43. Selector 46 connects either the output terminal of exclusive OR circuit 47 or the output terminal of selector 44 to exclusive OR circuit 48, according to the selector control signal supplied to its control input terminal 46C. Selector 45 connects either the output terminal of the rotate word (RotWord) operation unit 39 or the output terminal of selector 44 to the substitute word (SubWord) operation unit 40, according to the selector control signal supplied to its control input terminal 45C.

Selector 44 has four input terminals in addition to a control input terminal 44C. The four input terminals are connected to output terminals of register sets 32, 34, 36, and 38, respectively. Selector 44 selects and connects one of the four output terminals of these register sets 32, 34, 36, 38, to selector 46, according to the selector control signal supplied to its control input terminal 44C.

For encryption, selector 44 is controlled according to the size of the secret key PK1, but for decryption, selector 44 makes a constant selection, not depending on the size of the secret key PK1. More specifically, for encryption, selector 44 selects the output terminal of register set 34 when the size of the secret key PK1 is 128 bits, the output terminal of register set 36 when the size of the secret key PK1 is 192 bits, and the output terminal of register set 38 when the size of the secret key PK1 is 256 bits; for decryption, selector 44 always selects the output terminal of register set 32, regardless of the size of the secret key PK1.

The internal structure of the key expansion operation section 21B, which successively generates the working keys described above, corresponds to the program listings shown in FIGS. 4 and 5. More specifically, the rotate word operation unit 39, the substitute word operation unit 40, and the round constant (Rcon) operation unit 41 execute the computations corresponding to the RotWord function, SubWord function, and Rcon array in the program listings. Exclusive OR circuit 47 corresponds to the ‘xor’ operation in line L10 in FIG. 4 and line L50 in FIG. 5; exclusive OR circuit 48 corresponds to the ‘xor’ operations in line L20 in FIG. 4 and line L60 in FIG. 5.

Since the algorithms in FIGS. 4 and 5 are executed with 32-bit data width, all the registers in the key expander 21 in the present embodiment are 32 bits wide.

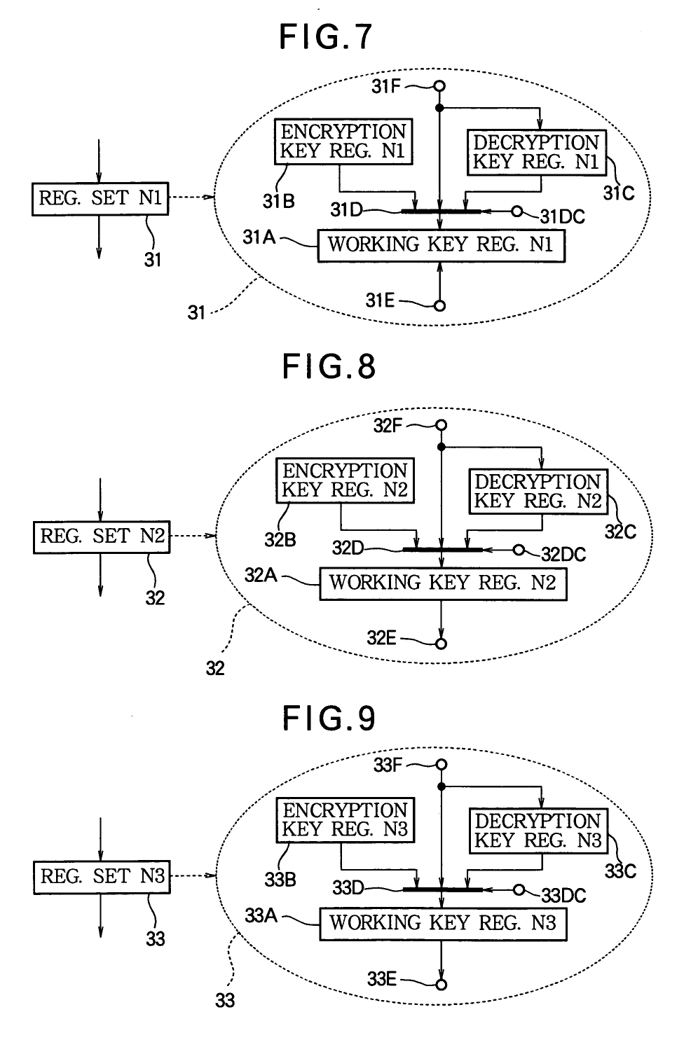

Each of the eight register sets 31-38 includes three registers. Each of the three registers is 32 bits wide. All eight register sets 31-38 have the same internal structure. The internal structure of register set 31 will be described below with reference to FIG. 7.

The register set 31 in FIG. 7 comprises a working key register 31A, an encryption key register 31B, a decryption key register 31C, an internal selector 31D, an output terminal 31E, and an input terminal 31F. The three registers 31A, 31B, 31C have the same rank N1 as the register set 31 to which they belong.

The encryption key register 31B stores the initial working key WK1 from which the generation and output of working keys starts in the encryption key expansion process in the present embodiment. This process corresponds to the generating procedure in the AES algorithm described above.

The decryption key register 31C similarly stores the initial working key WK44 from which the generation and output of working keys starts in the decryption key expansion process in the present embodiment.

During encryption, the working key register 31A successively stores working keys WK1 to WK44 as encryption keys. During decryption, the working key register 31A successively stores working keys WK44 to WK1 as decryption keys.

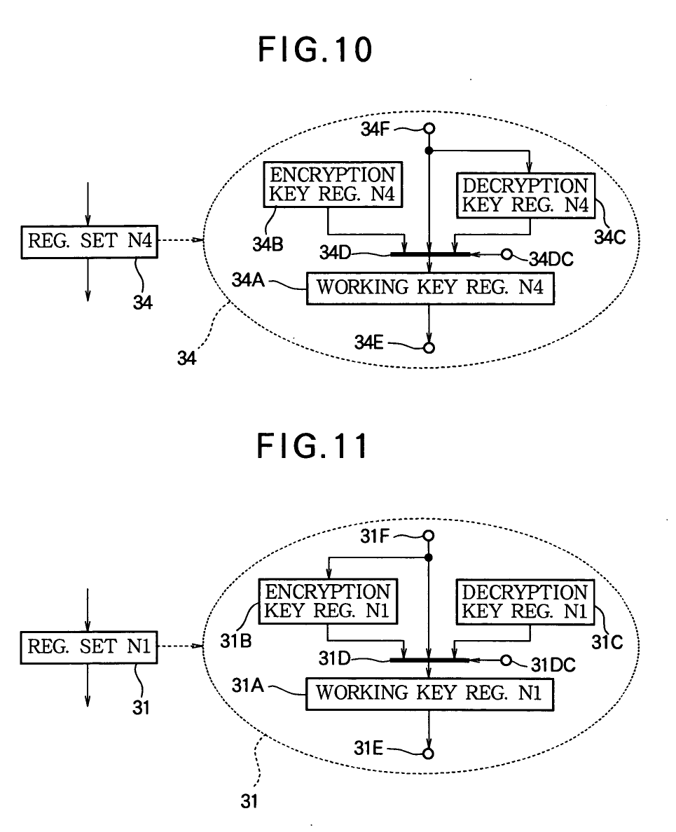

Register set 32 comprises a working key register 32A, an encryption key register 32B, a decryption key register 32C, an internal selector 32D, an output terminal 32E, and an input terminal 32F, as shown in FIG. 8. Register set 33 comprises a working key register 33A, an encryption key register 33B, a decryption key register 33C, an internal selector 33D, an output terminal 33E, and an input terminal 33F, as shown in FIG. 9. Register set 34 comprises a working key register 34A, an encryption key register 34B, a decryption key register 34C, an internal selector 34D, an output terminal 34E, and an input terminal 34F, as shown in FIG. 10. The registers in these three register sets 32, 33, 34 have ranks N2, N3, N4, respectively. All of the working key registers 31A, 32A, . . . , encryption key registers 31B, 32B, . . . , and decryption key registers 31C, 32C . . . are 32 bits wide, as noted above.

The internal selector 31D has a function similar to the function of the selectors (selector 42C, for example): it has three input terminals and an output terminal, and connects one of the input terminals to the output terminal according to an internal selector control signal (not shown) supplied to a control input terminal 31DC.

Immediately after the start of the encryption process, when the register unit 21A outputs working key WK1 and the key expansion operation section 21B generates working key WK5, the internal selector 31D selects the working key output by the encryption key register 31B. Immediately after the start of the decryption process, when the register unit 21A outputs working key WK44 and the key expansion operation section 21B generates working key WK40, the internal selector 31D selects the working key output by the decryption key register 31C.

After working key WK5 has been generated for encryption or working key WK40 has been generated for decryption, the internal selector 31D selects the working key supplied from the input terminal 31F. Since the input terminal 31F in register set 31 is connected to the output terminal 32E in register set 32, which is ranked immediately above register set 31, the working key (WK2 or WK43, for example) shifted out from register set 32 is supplied to and stored in working key register 31A, passing through the input terminal 31F and the internal selector 31D.

The output terminal of each of register sets 32-38 is generally connected to the input terminal of the next lower-ranked register set. Since register set 31 is the lowest-ranked register set, its output terminal 31E is connected to output terminal 21C and exclusive OR circuit 48.

Encryption and decryption operations using the key expander 21 of the present embodiment will be described below. In the following description, the data mixer 20 in the communication device 12 in FIG. 2 transmits encrypted data ED1 obtained by encrypting plaintext data D1, and decrypts encrypted data ED2 received as a response from the communication device 13. The encryption operation is performed in a series of steps S1, S2, . . . , SN, . . . and the decryption operation in a series of steps P1, P2, . . . , PN, . . . .

In this operation, the next working key is generated by computation from the working keys. stored in various registers (for example, encryption key registers 31B and 34B). It will be assumed that the computations performed by the key expansion operation section 21B are executed by the circuits specified in Federal Information Processing Standards Publication 197.

Working keys WK1-WK4, which are the initial encryption keys, are prestored in the four encryption registers 31B, 32B, 33B, 34B in register sets 31-34 before the first block of plaintext data D1 is supplied to the data mixer 20. More specifically, working key WK1 is stored in the encryption key register 31B in register set 31, working key WK2 in the encryption key register 32B in register set 32, working key WK3 in the encryption key register 33B in register set 33, and working key WK4 in the encryption key register 34B in register set 34.

Although the initial encryption keys WK1-WK4 can be generated directly from the secret key PK1, this process is not always necessary. If the communication device 12 includes a nonvolatile memory such as a hard disk or an electrically erasable and programmable read-only memory (EEPROM), the four initial working keys WK1-WK4 can be stored ahead of time in the nonvolatile memory and loaded into the appropriate registers before encryption begins.

As mentioned above, the secret key PK1 has a size of 128 bits, so the four highest register sets 35-38 are not used.

In the initial state (step S1), the internal selectors 31D, 32D, 33D, 34D in register sets 31-34 select the encryption key registers 31B, 32B, 33B, 34B and transfer the working keys WK1, WK2, WK3, WK4 stored therein to the working key registers 31A, 32A, 33A, 34A, which receive and store the working keys. As a result, working key WK1 is stored in the working key register 31A in register set 31, working key WK2 in the working key register 32A in register set 32, working key WK3 in the working key register 33A in register set 33, and working key WK4 in the working key register 34A in register set 34.

Working key WK1 is also supplied through the output terminal 31E of register set 31 to exclusive OR circuit 48 and the output terminal 21C; working key WK4 is supplied through the output terminal 34E of register set 34 to selector 44.

At step S2, working key WK1 is supplied from the output terminal 21C to the data mixer 20, and is used for the first mixing process performed on the first block of plaintext data D1 in the data mixer 20. A total of forty-four mixing processes will be performed to encrypt this block of plaintext data, using successive working keys WK1-WK44. Subsequent blocks will be encrypted in the same way to generate the encrypted data ED1.

At step S2, while the first mixing process is being executed on this first block or at substantially the same time, the key expansion operation section 21B, receives working keys WK1 and WK4 from register sets 31 and 34, and generates working key WK5 by the computation ‘f’ illustrated schematically in FIG. 6.

At step S3, the internal selectors 31D, 32D, 33D, 34D in register sets 31-34 select the input terminals 31-F, 32F, 33F, 34F and register sets 31-34 operate as a single shift register. As a result, working key WK4, which was stored in the working key register 34A in register set 34, is shifted into and stored in the working key register 33A in register set 33, working key WK3 is similarly shifted from register set 33 into register set 32, and working key WK2 is similarly shifted from register set 32 into register set 31. Working key WK5 is shifted from exclusive OR circuit 48 through selector 42 into register set 34 and stored in the working key register 34A therein. After this shift, working keys WK2-WK5 are stored in the working key register 31A in register set 31, the working key register 32A in register set 32, the working key register 33A in register set 33, and the working key register 34A in register set 34, respectively.

After steps S2 and S3, an operation basically similar to the operation in steps S2 and S3 is repeated to generate and output successive working keys, ending when the forty-fourth working key WK44 is output from the output terminal 21C. The working keys WK1-WK44 are used to encrypt the first block of plaintext data. Next, the first working key WK1 is output from the output terminal 21C again, and the same series of steps is repeated to encrypt the second block of plaintext data. The entire series of steps can be repeated an arbitrary number of times to encrypt plaintext data D1 of arbitrary length, each repetition constituting one key expansion cycle.

Since a major feature of the operation in the present embodiment lies in the processing that takes place while working keys WK41-WK44 are generated and output at the end of the key expansion cycle, the description will now focus on the processing during this period, starting with step SN, which is the step corresponding to step S2 carried out when working key WK37 is output from the output terminal 21C.

At step SN, working key WK37 is supplied from the output terminal 21C to the data mixer 20 and used to mix (encrypt) plaintext data D1. Working key WK37 is also supplied to exclusive OR circuit 48, and working key WK40 is supplied from register set 34 to selector 44, enabling the key expansion operation section 21B to generate working key WK41.

At the next step SN+1, working key WK41 is shifted from the key expansion operation section 21B into register set 34, and working keys WK40-WK38 are shifted into register set 33, register set 32, and register set 31, respectively, generally as explained in step S3. This time, however, working key WK41 is stored not only in the working key register 34A but also in the decryption key register 34C in register set 34. This is because working key WK41 will be used as an initial working key when the decryption process is executed.

Since the goal is to reach a final state from which decryption can start at any time (to leave the register unit 21A in a ready-to-decrypt state), and since in this state working keys WK44-WK41 must be stored in decryption key registers 31C, 32C, 33C, and 34C, as working keys WK42-WK44 are shifted toward register set 31, they are also stored in the appropriate decryption key registers. More specifically, working key WK42 is stored in the decryption key register 33C in register set 33 in step SN+5, working key WK43 is stored in the decryption key register 32C in register set 32 in step SN+9, and working key WK44 is stored in the decryption key register 31C in register set 31 in step SN+13. The last three working keys WK42-WK44 output in the encryption cycle are thus loaded into decryption key registers 33C, 32C, and 31C from working key registers 34A, 33A, and 32A, respectively, and the preceding working key WK41 is loaded into decryption key register 34C from the operation unit 21B.

As shown in FIGS. 7 to 10, the working key shifted in at the input terminal of each register set (input terminal 31F, for example) is always supplied to the decryption key register (decryption key register 31C, for example) in that register set. Whether the supplied working key is stored in the decryption key register or not depends on a control signal (not shown) that enables and disables the storing operation. If the storing operation is enabled, the newly shifted working key is stored in the decryption key register; if the storing operation is disabled, the working key already stored in the decryption key register remains stored.

Accordingly, the shifting and storing operations are controlled so that when working key WK42 is shifted into register set 33, it is stored in the decryption key register 33C; when working key WK43 is shifted into register set 32, it is stored in the decryption key register 32C; and when working key WK44 is shifted into register set 31, it is stored in decryption key register 31C. At the end of the encryption cycle, the register unit 21A is therefore in the ready-to-decrypt state.

While the decryption key registers (decryption key register 31C, for example) are storing the necessary working keys in order to enter the ready-to-decrypt state as described above, shifting of the working keys between registers continues normally, and the working keys (WK41, for example) are output in the normal sequence from the output terminal 21C, so that the encryption process carried out by the data mixer 20 can continue.

Unless the size of the plaintext data D1 is particularly small, the key expansion cycle will be executed repeatedly, but the storing operations for entering the ready-to-decrypt state only have to be performed in the first cycle. Once stored in the decryption key registers, the working keys can be left stored during the subsequent encryption cycles; repetition of the storing operations after the first cycle is unnecessary.

Regardless of the size of the plaintext data D1, when the communication device 12 (the data mixer 20) has finished transmitting the encrypted data ED1 obtained by encrypting the plaintext data D1, the register unit 21A is in the ready-to-decrypt state.

When the communication device 12 receives the encrypted data ED2 transmitted from the communication device 13 in response to encrypted data ED1, the data mixer 20 executes the mixing process for decrypting data ED2. This mixing process requires output of the working keys WK44-WK1 from the output terminal 21C in the reverse order of the order used for encryption.

First working keys WK44-WK41 must be output, so the step at the start of decryption differs from step S1. The internal selectors 31D, 32D, 33D, 34D in register sets 31-34 select the decryption key registers 31C, 32C, 33C, 34C and transfer the working keys stored in the decryption key registers 31C, 32C, 33C, 34C to the working key registers 31A, 32A, 33A, 34A (step P1).

As a result, the necessary initial working keys WK44-WK41 are stored in the working key registers 31A, 32A, 33A, 34A of register sets 31-34. More specifically, working key WK44 is stored in the working key register 31A in register set 31, working key WK43 is stored in the working key register 32A in register set 32, working key WK42 is stored in the working key register 33A in register set 33, and working key WK41 is stored in the working key register 34A in register set 34.

The key expansion operations, including the output of the working keys (WK44, WK43, . . . ) from the output terminal 21C, generation of working keys in the key expansion operation section 21B, storing of the generated working keys in the working key register 34A in register set 34, and shifting of the working keys, are then executed as they were for encryption.

Accordingly, decryption steps P2, P3, . . . , PN, . . . are identical to encryption steps S2, S3, SN, . . . , except for the different setting of selector 44. Also, the working keys shifted into register sets 34, 33, 32, and 31 in steps PN+1, PN+5, PN+9, and PN+13 are not stored in the decryption key registers 34C, 33C, 32C, 31C, since these registers already store the appropriate initial decryption keys.

As described above, the decryption process can start without the need for extra operations to load the initial decryption keys into the decryption key registers. Thus the decryption process can start without delay, and without the need to change the internal state of the communication device.

The decryption process may be carried out so that at the end of the decryption cycle, the register unit 21A is left in a ready-to-encrypt state, simply by leaving the initial encryption keys that were loaded into the encryption key registers 31B, 32B, 33B, 34B before step S1 stored in the encryption key registers. Similarly, after the first key expansion cycle, the initial decryption keys can simply be left in the decryption key registers 31C, 32C, 33C, 34C.

There are likely to be many cases in which a single communication device such as communication device 12 uses different secret keys (one of them being secret key PK1) to transmit encrypted data to different destination devices. Providing a different key expander 21 for each destination may require too much circuitry to be practical, but in such cases, the same key expander can be used for all destinations and the contents of the encryption key registers and decryption key registers can be overwritten with new initial keys as the need arises.

As described above, according to the present embodiment, only a minimum number of working keys (WK1-WK4, for example) have to be prestored, which conserves memory space and contributes to the provision of low-priced, small-size communication devices, including such devices as smart cards and IC tags.

In the present embodiment, when an encryption cycle ends, the register unit 21A is left in an internal state from which decryption can start at any time (the ready-to-decrypt state), and when a decryption cycle ends, the register unit 21A can be left in an internal state from which encryption can start at any time (the ready-to-encrypt state), so the encryption and decryption processes can be executed efficiently and an alternating series of encryption and decryption processes can be carried out at high speed.

In the embodiment described above, processing starts with the storing of the initial encryption keys WK1-WK4 in the encryption key registers 31B, 32B, 33B, 34B in the four register sets 31-34. In a variation of this embodiment, processing starts with the storing of the initial decryption keys WK44-WK41 instead of the initial encryption keys WK1-WK4. This variation is particularly useful in a device that normally receives encrypted data before transmitting encrypted data.

The initial decryption keys WK44-WK41 must then be prestored in the decryption key registers 31C, 32C, 33C, 34C in register sets 31-34. The initial decryption keys can be loaded into the decryption key registers 31C, 32C, 33C, 34C from a nonvolatile memory, or can be generated from the secret key PK1. The decryption key registers 31C, 32C, 33C, 34C need not be coupled to the input terminals 31F, 32F, 33F, 34F in register sets 31-34. The encryption key registers 31B, 32B, 33B, 34B must be connected to the input terminals 31F, 32F, 33F, 34F instead, as shown in FIG. 11, and the initial encryption keys WK1-WK4 must be stored in the encryption key registers at the end of the first key expansion cycle.

Although the size of the secret key PK1 was 128 bits in the above embodiment, the present invention is applicable to secret keys of different sizes, including sizes of 192 bits and 256 bits.

The present invention is not limited to use with the AES standard. If can also be applied to the Rijndael cipher, for example, and to any other block cipher that requires sequences of encryption and decryption keys to be generated in the manner described above.

In the embodiment above, the invention was described as being implemented in hardware, but the invention can be also implemented in software.

When the present invention is implemented in software, the registers in the register sets may comprise any type of readable and writable memory, such as general-purpose registers in a general-purpose computational device, or memory locations in a random-access memory (RAM). The various selectors, exclusive-OR logic circuits, and hardware operation units (such as the rotate word operation unit 39, for example) can be replaced by equivalent instructions executable by a central processing unit (CPU) or another type of processor.

Those skilled in the art will recognize that further variations are possible within the scope of the invention, which is defined in the appended claims.

What is claimed is:

1. A key expander for generating N working keys from a secret key used in a common-key cryptographic scheme, N being a positive integer, the N working keys being used in a predetermined order in an encryption cycle and the reverse order in a decryption cycle, the key expander comprising:
an operation unit for executing a computational process that generates successive ones of the working keys from preceding ones of the working keys, in either the predetermined order or the reverse order;
M working key registers, M being a positive integer less than N, linked to form a shift register from which the working keys are supplied to the operation unit, the shift register also receiving the working keys successively generated by the operation unit, storing and shifting the received working keys, and outputting the working keys one by one for use in encryption and decryption;
M encryption key registers, each coupled to a corresponding one of the M working key registers, for storing the first M working keys in the predetermined order and transferring said first M working keys to the M working key registers to start an encryption cycle; and
M decryption key registers, each coupled to a corresponding one of the M working key registers, for storing the last M working keys in the predetermined order and transferring said last M working keys to the M working key registers to start a decryption cycle; wherein
the last M working keys output in at least one encryption cycle or decryption cycle are also transferred into the M decryption key registers or the M encryption key registers and stored therein.

2. The key expander of claim 1, wherein the last M working keys output in an encryption cycle are transferred into the M decryption key registers and stored therein, leaving the key expander ready for a decryption cycle.

3. The key expander of claim 1, wherein the last M working keys output in a decryption cycle are transferred into the M encryption key registers and stored therein, leaving the key expander ready for an encryption cycle.

4. The key expander of claim 1, further comprising M selectors, each of the M selectors having an output terminal connected to one of the M working key registers, a first input terminal connected to a preceding one of the M working key registers or to the operation unit, a second input terminal connected to one of the M encryption key registers, and a third input terminal connected to one of the M decryption key registers.

5. The key expander of claim 4, wherein each of the M decryption key registers also has an input terminal connected to said preceding one of the M working key registers or to the operation unit.

6. The key expander of claim 4, wherein each of the M encryption key registers also has an input terminal connected to said preceding one of the M working key registers or to the operation unit.

7. The key expander of claim 1, wherein the secret key has different possible bit lengths, and the shift register formed by the M working key registers has a total bit length equal to a maximum one of the possible bit lengths of the secret key, further comprising:
a first selector for routing the working keys generated by the operation unit to different ones of the M working key registers, depending on the bit length of the secret key; and
a second selector for supplying the working keys from different ones of the M working key registers to the operation unit, depending on the bit length of the secret key.

8. A method of expanding a secret key used in a common-key cryptographic scheme into N working keys, N being a positive integer, the N working keys being used in a predetermined order in an encryption cycle and the reverse order in a decryption cycle, the method comprising:
executing a first computational process that generates successive ones of the working keys from preceding ones of the working keys in the predetermined order;
executing a second computational process that generates successive ones of the working keys from preceding ones of the working keys in the reverse order;
shifting the working keys generated by the first computational process and the second computational process through a shift register formed from M working key registers, M being a positive integer less than N;
outputting the working keys from the shift register one by one for use in encryption and decryption;
storing the first M working keys in the predetermined order in M encryption key registers, each coupled to a corresponding one of the M working key registers;
transferring the first M working keys from the M encryption key registers to the M working key registers to start an encryption cycle;
storing the last M working keys in the predetermined order in M decryption key registers, each coupled to a corresponding one of the M working key registers; and
transferring the last M working keys from the M decryption key registers to the M working key registers to start a decryption cycle; wherein
either said storing the first M working keys or said storing the last M working keys is performed by transferring the last M working keys output in at least one encryption cycle or decryption cycle into the M decryption key registers or the M encryption key registers during said at least one encryption cycle or decryption cycle.

9. The method of claim 8, wherein the last M working keys output in an encryption cycle are transferred into the M decryption key registers and stored therein.

10. The method of claim 9, wherein the last M−1 working keys output in the encryption cycle are transferred into M−1 of the decryption key registers from M−1 of the working key registers.

11. The method of claim 8, wherein the last M working keys output in a decryption cycle are transferred into the M encryption key registers and stored therein.

12. The method of claim 11, wherein the last M−1 working keys output in the decryption cycle are transferred into M−1 of the encryption key registers from M−1 of the working key registers.

13. The method of claim 8, wherein the secret key has different possible bit lengths, and the shift register formed by the M working key registers has a total bit length equal to a maximum one of the possible bit lengths of the secret key, further comprising:
selecting different ones of the M working key registers to receive the working keys generated by the operation unit, depending on the bit length of the secret key; and
selecting different ones of the M working key registers from which to supply the working keys to the operation unit, depending on the bit length of the secret key.

14. A machine-readable recording medium storing machine-executable instructions for expanding a secret key used in a common-key cryptographic scheme into N working keys, N being a positive integer, the N working keys being used in a predetermined order in an encryption cycle and the reverse order in a decryption cycle, the machine-executable instructions including:
instructions for executing a first computational process that generates successive ones of the working keys from preceding ones of the working keys in the predetermined order;
instructions for executing a second computational process that generates successive ones of the working keys from preceding ones of the working keys in the reverse order;
instructions for shifting the working keys generated by the first computational process and the second computational process through a shift register formed from M working key registers, M being a positive integer less than N, and outputting the working keys from the shift register one by one for use in encryption and decryption;
instructions for storing the first M working keys in the predetermined order in M encryption key registers, each coupled to a corresponding one of the M working key registers;
instructions for transferring the first M working keys from the M encryption key registers to the M working key registers to start an encryption cycle;
instructions for storing the last M working keys in the predetermined order in M decryption key registers, each coupled to a corresponding one of the M working key registers; and
instructions for transferring the last M working keys from the M decryption key registers to the M working key registers to start a decryption cycle; wherein
either the instructions for storing the first M working keys or the instructions for storing the last M working keys transfer the last M working keys output in at least one encryption cycle or decryption cycle into the M decryption key registers or the M encryption key registers during said at least one encryption cycle or decryption cycle.

15. The machine-readable recording medium of claim 14, wherein the last M working keys output in an encryption cycle are transferred into the M decryption key registers and stored therein.

16. The machine-readable recording medium of claim 15, wherein the last M−1 working keys output in the encryption cycle are transferred into M−1 of the decryption key registers from M−1 of the working key registers.

17. The machine-readable recording medium of claim 14, wherein the last M working keys output in a decryption cycle are transferred into the M encryption key registers and stored therein.

18. The machine-readable recording medium of claim 17, wherein the last M−1 working keys output in the decryption cycle are transferred into M−1 of the encryption key registers from M−1 of the working key registers.

19. The machine-readable recording medium of claim 14, wherein the secret key has different possible bit lengths, and the shift register formed by the M working key registers has a total bit length equal to a maximum one of the possible bit lengths of the secret key, the machine-executable instructions further including:
instructions for selecting different ones of the M working key registers to receive the working keys generated by the operation unit, depending on the bit length of the secret key; and
instructions for selecting different ones of the M working key registers from which to supply the working keys to the operation unit, depending on the bit length of the secret key.
